(19) United States
(12) Patent Application Publication
(10) Pub. No.: US 2010/0064061 A1
(43) Pub. Date: Mar. 11, 2010

(54) PROVIDING SUBSTANTIALLY IMMEDIATE ACTION IN RESPONSE TO INPUT EVENT

(75) Inventors: Daniel A. Warren, San Jose, CA (US); Matthew Rogers, Sunnyvale, CA (US); John Sullivan, Sunnyvale, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/205,085

(22) Filed: Sep. 5, 2008

(51) Int. Cl. G06F 3/00

(52) U.S. Cl. 710/5

(57) ABSTRACT

Apparatus and methods for setting up an action on an electronic device before an input is confirmed and performing the action once the input is confirmed are provided. The amount of time needed to perform the action in response to detecting an input may be reduced by an amount of time equivalent to the lesser of the wait time used to confirm the input or the time needed to set up the action. The electronic device may set up a predicted action to be performed substantially immediately following confirmation of the input.

### FIELD OF THE INVENTION

This relates to apparatus and methods for setting up an action with an electronic device before an input is confirmed and performing the action once the input is confirmed.

### BACKGROUND OF THE DISCLOSURE

To perform an action, an electronic device may detect an input and may wait until the input is confirmed before performing an action in response to the detected input. For example, when a user presses a button on an electronic device (e.g., to request that a music file be played), the electronic device may detect the button press, wait a predetermined length of time before confirming the button press, and then set up an appropriate action corresponding to the button press (e.g., prepare the music file to be played), and performing the action (e.g., play the music file). During the predetermined wait time, the electronic device may not initiate the set up of the appropriate action corresponding to the confirmed button press. After the action has been confirmed, it may take on the order of one hundred milliseconds to set up and to perform the action. As a result, there may be an extended delay between confirming the input and performing the corresponding action because the action must first be set up on the electronic device.

Therefore, it would be beneficial to enhance the response time of the electronic device by providing methods for setting up an action before the input is confirmed and reducing the wait time between confirming the input and performing the action. In addition, it would be beneficial to provide methods for performing the action substantially immediately after the input is confirmed.

### SUMMARY OF THE DISCLOSURE

Apparatus and methods for setting up an action on an electronic device before an input is confirmed and performing the action once the input is confirmed are provided. In one embodiment, an electronic device for initiating a set up of an action is provided. The electronic device may include an input mechanism operative to receive an input and control circuitry. The control circuitry may be operative to detect the input, predict at least one action to perform in response to the detected input, set up the at least one action, confirm the input, and perform the at least one action in response to the confirmed input.

In one embodiment, a method for initiating a set up of an action on an electronic device is provided. The method may include detecting an input, confirming the input, initiating the set up of at least one action in response to detecting the input and before the input is confirmed, and performing the at least one action.

In one embodiment, a computer-readable media encoded with machine readable instructions for initiating an action on an electronic device is provided. The computer-readable media may include instructions for detecting an input, predicting at least one action to perform in response to detecting the input, confirming the input, initiating the set up of the at least one action in response to predicting the at least one action and before the input is confirmed, and performing the at least one action in response to confirming the input.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1 is a schematic view of an electronic device in accordance with some embodiments of the invention;

FIG. 2 is a front view of an illustrative electronic device having an output mechanism and an input mechanism in accordance with some embodiments of the invention;

FIG. 3 is a schematic view of a timeline for detecting an input, setting up an action, confirming the input, and performing the action in accordance with some embodiments of the invention;

FIG. 4 is a flowchart of an illustrative process for setting up an action while an input is being confirmed in accordance with some embodiments of the invention; and

FIG. 5 is a flowchart of an illustrative process for detecting a first input and a second input in accordance with some embodiments of the invention.

### DETAILED DESCRIPTION OF THE DISCLOSURE

In some embodiments of the invention, an electronic device capable of detecting an input, setting up an action in response to the input, confirming the input, and performing the action may be provided. The electronic device may include any suitable device for receiving inputs in any suitable form. The electronic device may include an output mechanism, an input mechanism, playback circuitry, control circuitry, and any other suitable components. The control circuitry may include additional circuitry that may analyze and confirm the input and may carry out an action corresponding to the confirmed input.

In some embodiments of the invention, an electronic device may prepare for or set up an action that it predicts it may perform once an input has been detected, but before the input has been confirmed. The action may in turn be performed after the input has been confirmed. The input may be of any suitable form to be detected by the electronic device, such as a mechanical or electrical signal or instruction and including a signal or instruction that may be transmitted to the electronic device using any suitable control circuitry. The input may be detected by the electronic device at or shortly after the initiation of the input. The input may include any suitable characteristics, such as a leading edge, a trailing edge, a logic level transition, or a fluctuation over any suitable time interval. In some embodiments, the input may fluctuate due to contact bounce. The electronic device may wait any suitable amount of time to debounce the input before confirming it. The wait time may permit the electronic device to avoid detecting the contact bounce and to avoid incorrectly confirming an input.

In some embodiments of the invention, an electronic device may set up at least one action predicted by the electronic device to be performed in response to a detected input. While the input is being confirmed by the electronic device, the electronic device may set up simultaneously any suitable number of predicted actions using any suitable method. For example, the control circuitry may process any suitable number of operations during the wait time to set up at least one action that the control circuitry predicts may be performed by the electronic device once the input is confirmed. In some embodiments, the control circuitry may set up any suitable number of actions using a spatial approach. For example, the control circuitry may set up any suitable number of actions that the control circuitry predicts could be performed in response to an input detected within a given radius or area of the actual input. In some embodiments, the control circuitry may set up any suitable number of actions that the control circuitry predicts could be performed in response to an input within a similar context to the actual input. The step or steps included in setting up the action or actions may depend on what action or actions may be predicted by the control circuitry to be performed in response to a detected input. Because the length of time required to set up of a predicted action may depend on the number and the complexity of the steps associated with the action, the set up of the predicted action may be completed prior to, concurrently with, or following the confirmation of the input.

In some embodiments of the invention, the predicted action that may correspond to the confirmed input may be performed substantially immediately following the confirmation. For example, the process to set up the action may have been completed during the wait time, or concurrently with the end of the wait time, so that the action may be performed substantially immediately following the confirmation of the input. In some embodiments, the set up of the action may exceed the duration of the wait time, in which case the action may be substantially immediately performed following completion of the set up. Therefore, an action may be performed without waiting for the action to be set up only after the input has first been confirmed. The amount of time needed to perform the action may be reduced by an amount of time equivalent to the wait time used to confirm the input. In the instances where the set up time does not exceed the duration of the wait time, the amount of time needed to perform the action after detecting the input may be reduced by an amount of time equivalent to the set up time.

In some embodiments of the invention, the electronic device may set up one or more actions that the electronic device predicts may be performed in response to the input. If none of the actions set up by the electronic device correspond to the input after the input is confirmed, the set up actions may be flushed and the electronic device may set up and perform an action that may correspond to the confirmed input.

In some embodiments of the invention, the electronic device may detect a first input and may perform an action predicted to correspond to the detected input before the input may be confirmed and before the input may be stabilized. The electronic device then may allow any suitable amount of time to elapse between performing the first action and detecting a second input. The elapsed time may allow the electronic device to ensure that the first input has been fully debounced before allowing another input to trigger the confirmation, set up, and performance of a second action. This process may ensure that any single input may not be erroneously interpreted as two separate events without having to introduce any additional latency period to permit the first input to stabilize.

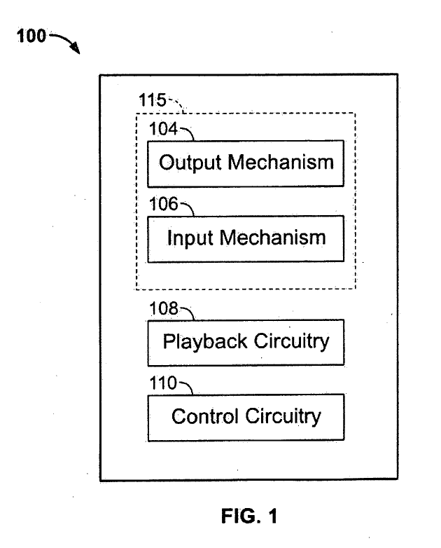

Apparatus and methods for setting up an action on an electronic device before an input is confirmed and performing the action once the input is confirmed are provided and described with reference to FIGS. 1-5.

FIG. 1 is a schematic view of an electronic device in accordance with some embodiments of the invention. The electronic device may include any suitable device for receiving inputs. For example, electronic device 100 may include a desktop computer, a laptop computer, a device capable of communicating wirelessly (with or without the aid of a wireless enabling accessory system) or via wired pathways (e.g., using traditional electrical wires), a pocket-sized personal computer such as an iPAQ Pocket PC™ available by Hewlett Packard Inc. of Palo Alto, Calif., a personal digital assistant (“PDA”), a personal e-mail or messaging device with audio and/or video capabilities (e.g., a Blackberry™ available by Research In Motion LTD of Waterloo, Ontario), or an iPod™, an iPod™ nano, an iPod Shuffle™, an iPod Touch™ or an iPhone™ available by Apple Inc. of Cupertino, Calif. The electronic device may perform a single function, such as playing music, or the electronic device may perform multiple functions, such as playing music, displaying video, storing pictures, and/or receiving and transmitting telephone calls. The input may take any suitable form, including but not limited to, voice instruction, data instruction, manual instruction (e.g., a keystroke), an instruction from a program installed in electronic device 100, an instruction based upon a sensed condition (e.g., an input related to a user manipulating input mechanism 106 or output mechanism 104), or combinations thereof.

Electronic device 100 may include output mechanism 104, input mechanism 106, playback circuitry 108, control circuitry 110, and any other suitable components. All of the applications employed by output mechanism 104, input mechanism 106, and playback circuitry 108 may be interconnected and managed by control circuitry 110.

Input mechanism 106 may include any suitable mechanism for providing inputs or instructions to electronic device 100. Input mechanism 106 may take a variety of forms, such as an electronic device pad, touch screen, one or more buttons (e.g., a keyboard), mouse, joystick, track ball, keypad, dial, switch, actuator, scroll wheel, click wheel, or combinations thereof. The user interface may include a multi-touch screen such as that described in Westerman et al., U.S. Pat. No. 6,323,846, issued Nov. 27, 2001, which is incorporated by reference herein in its entirety. The user interface may emulate a rotary phone or a multi-button keypad, which may be implemented on a touch screen or the combination of a click wheel or other user input device and a screen. Input mechanism 106 may be configured to provide one or more dedicated control functions for making selections or issuing commands associated with electronic device 100. In some embodiments, input mechanism 106 may include a remote input mechanism, including for example, a headset with one or more buttons and an optional microphone, that may be coupled to electronic device 100.

One or more output mechanisms 104 may be provided to present information (e.g., textual, graphical, audible, and/or tactile information) to a user of electronic device 100. Output mechanism 104 may take various forms, including, but not limited, to audio speakers, headphones, audio line-outs, visual displays, antennas, infrared ports, rumblers, vibrators, or combinations thereof.

In some embodiments, output mechanism 104 may include any suitable audio component for providing audio to the user of electronic device 100. For example, output mechanism 104 may include one or more speakers (e.g., mono or stereo speakers) built into electronic device 100. In some embodiments, output mechanism 104 may include an audio component that is remotely coupled to electronic device 100, such as a headset, headphones or earbuds that may be coupled to electronic device 100 with a wire (e.g., coupled to electronic device 100 with a jack) or wirelessly (e.g., Bluetooth™ headphones or a Bluetooth™ headset).

Output mechanism 104 also may include any suitable screen or projection system for providing a display visible to the user. For example, output mechanism 104 may include a screen (e.g., an LCD screen) that is incorporated in electronic device 100. As another example, output mechanism 104 may include a movable display or a projecting system for providing a display of content on a surface remote from electronic device 100 (e.g., a video projector). Output mechanism 104 may be operative to display content (e.g., information regarding a selected media file) under the direction of control circuitry 110.

It should be noted that one or more input mechanisms and one or more output mechanisms may sometimes be referred to collectively herein as an I/O interface (e.g., input mechanism 106 and output mechanism 104 as I/O interface 115). It should also be noted that input mechanism 106 and output mechanism 104 may sometimes be a single I/O component, such as a touch screen that may receive input information through a user's touch of a display screen and that may also provide visual information to a user via that same display screen.

Playback circuitry 108 may be any suitable circuitry operative to read, classify, store, play and transmit different types of media to an active output such as output mechanism 104 (e.g., audio or video) at the direction of control circuitry 110. Playback circuitry 108 may be operative to interface with control circuitry 110 to play any suitable media item, or any suitable number of media items either continuously or simultaneously, as selected by a user of electronic device 100. In some embodiments, playback circuitry 108 may be incorporated in control circuitry 110.

Control circuitry 110 may be operative to control the operations and performance of electronic device 100. Control circuitry 110 may include, for example, a processor, a bus (e.g., for sending instructions to the other components of electronic device 100), memory, storage, or any other suitable component for controlling the operations of electronic device 100. In some embodiments, a processor may drive output mechanism 104 and process inputs received from input mechanism 106 (e.g., a touch screen or a click wheel). The memory and storage may include, for example, a hard-drive, cache, Flash, ROM, and/or RAM, any other suitable type of storage component, or any combination thereof. In some embodiments, the memory may include cache memory, which may include one or more different types of memory used for temporarily storing data for electronic device applications. The memory may store media data (e.g., music, image, and video files), software (e.g., for implementing functions on electronic device 100), or the memory may be specifically dedicated to storing firmware (e.g., for device applications such as an operating system, user interface functions, and processor functions). In some embodiments, the memory may be operative to store a media item that electronic device 100 may download from a host system. Alternatively, control circuitry 110 may stream the media item from a source to make the media item available for playback without storing the media item in the memory.

Control circuitry 110 may be operative to perform the operations of one or more applications implemented on electronic device 100. Any suitable number or type of applications may be implemented. For example, in response to receiving a user input requesting that a music media item be played by a music application, control circuitry 110 may perform any suitable number of operations (e.g., accessing, reading, parsing, and decoding a music file and sending the decoded stream to an output buffer) to prepare playback circuitry 108 to perform the action. Although the following discussion may enumerate different applications, it will be understood that some or all of the applications may be combined into one or more applications. In some embodiments, electronic device 100 may include one or several applications or firmware operative to detect an input, confirm an input, set up an action predicted to correspond to the input, and perform the predicted action (e.g., download and/or play a variety of stored or streaming media items such as songs, videos, movies, or photographs), and electronic device 100 may perform the operations of these applications individually or simultaneously.

Control circuitry 110 may include additional circuitry (e.g., logic circuitry) that may analyze an input received by electronic device 100 and may carry out an action corresponding to the input. The input may be analyzed to confirm the appropriate action to be taken by the electronic device in response to the input. For example, if a user selects a music file to be played back, the selection may be analyzed by the electronic device to confirm that the user input corresponds to an action of playing back a music file rather than, for example, an action of presenting a menu containing different video settings to the user. Once the user input is confirmed by control circuitry 110, the action corresponding to the input may be performed.

In immediate response to detecting an input, an electronic device may prepare for, or set up, an action that it predicts it may perform using any suitable approach. The action may then be performed after the input has been confirmed. An input may be provided to the electronic device using any suitable input mechanism 106, including for example an interface that includes a touch screen, a “home” button, a click wheel, combinations thereof, or any other suitable input mechanism.

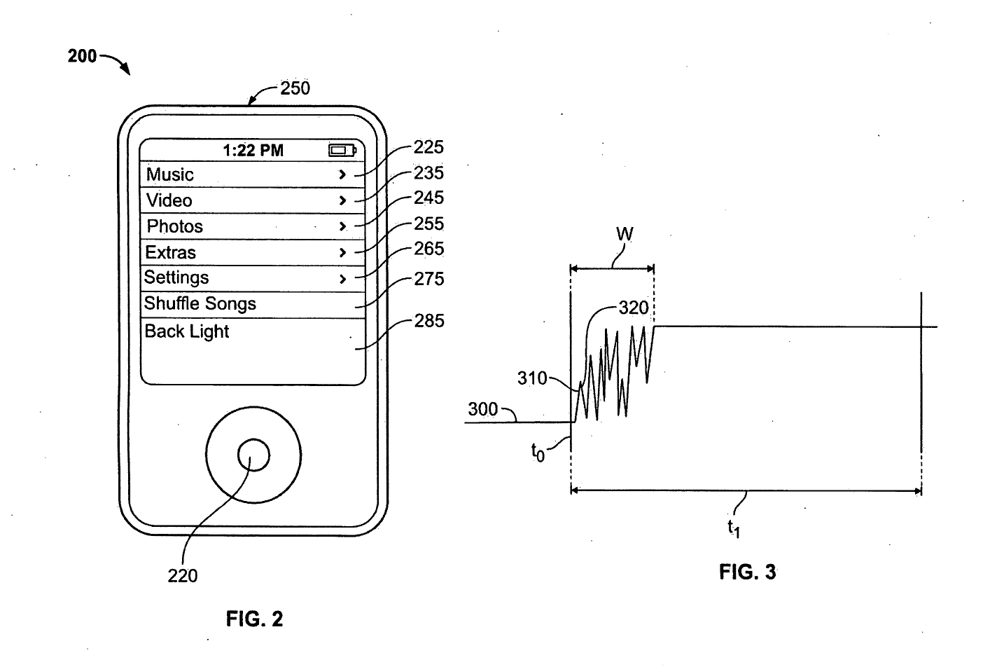

FIG. 2 is a front view of an illustrative electronic device 250 having an output mechanism and an input mechanism in accordance with some embodiments of the invention. Electronic device 250 may be the same as, and may include some or all of the features of, electronic device 100. Display screen 200, which may be the same as, and may include some or all of the features of, output mechanism 104 (FIG. 1) may be displayed when electronic device 250 is turned on (e.g., display screen 200 may represent the “home” screen of electronic device 250). Electronic device 250 may be a self-contained media player that may include an input mechanism 220 and an output mechanism (e.g., display screen 200). In some embodiments, electronic device 250 may be a self-contained media player with an I/O interface that combines the input and output mechanisms (e.g., a touch screen).

Display screen 200 may include any suitable orientation, such as a portrait-type orientation as shown, or a landscape-type orientation (not shown). The orientation of display screen 200 may depend on the shape and orientation of electronic device 250 relative to display screen 200. In some embodiments, display screen 200 may alter its orientation as the orientation of electronic device 250 changes. For example, if electronic device 250 is tilted or rotated in a particular direction, display screen 200 may similarly rotate in the same direction to maintain the same orientation relative to the position of electronic device 250.

Inputs may be provided to electronic device 250 using any suitable method, such as via input mechanism 220. In one embodiment, as shown, input mechanism 220 may be a rotational input device, such as a click wheel, and the output mechanism, or display screen 200, may be a video display, each of which may be found on certain iPods™ available by Apple Inc. of Cupertino, Calif. In some embodiments, a user may provide inputs to electronic device 250 by touching display screen 200 or by providing a voice command that may be detected by electronic device 250 (e.g., electronic device 250 may be coupled to a microphone or may include a microphone within control circuitry 110).

In some embodiments, display screen 200 may include several selectable options for operating different applications of electronic device 250. Options may include, for example, Music option 225, Video option 235, Photos option 245, Extras option 255, Settings option 265, Shuffle Songs option 275, Backlight option 285, or any other suitable option. One or more of the options may appear on display screen 200 regardless of the application currently being operated by electronic device 250.

For example, a user of electronic device 250 may select Music option 225 to listen to, download, organize and store music media items on electronic device 250. Video option 235 may be selected to display and organize video media stored within electronic device 250 or capable of being streamed to electronic device 250 for viewing. Photos option 245 may allow the user to display and organize photographs captured by, stored in, or streamed to electronic device 250. Extras option 255 may allow the user to display and review additional applications stored in electronic device 250, such as a clock function, a contacts listing, a calendar application, a notes application, a games listing, and any other suitable additional applications. Settings option 265 may be selected to review or alter the background settings of electronic device 250. Shuffle Songs option 275 may allow the user to reorder the playback of any suitable number of music media items, if any, which may be currently stored in or streamed to electronic device 250. Backlight option 285 may be selected to alter the appearance of display screen 200 by lighting it or by removing lighting from it.

If an input has been detected by electronic device 250 (e.g., a user has selected Shuffle Songs option 275), electronic device 250 may simultaneously begin an analysis to confirm the input while also setting up an action that electronic device 250 predicts may be performed (e.g., to shuffle the music media items available for playback) once the detected input has been confirmed. FIG. 3 is a schematic view of a timeline for detecting an input, setting up an action, confirming the input, and performing the action in accordance with some embodiments of the invention. Input 300 may be of any suitable form to be detected by an electronic device (e.g., electronic device 250, FIG. 2). For example, input 300 may include a mechanical or electrical signal or instruction. In some embodiments, input 300 may include a signal or instruction that may be transmitted to electronic device 250 using any suitable control circuitry (e.g., control circuitry 110, FIG. 1). Input 300 may be generated in any suitable fashion, including, for example, when a user depresses input mechanism 220 on electronic device 250. In some embodiments, input 300 may be detected by electronic device 250 at or shortly after time t0, immediately following the initiation of input 300 (e.g., a button press by the user on input mechanism 220). Input 300 may include any suitable characteristics, such as a first leading edge 310, a first trailing edge 320, or any other suitable characteristics.

In some embodiments, input 300 may fluctuate over any suitable time interval, such as interval w. Interval w may be of any suitable length of time, such as five to ten milliseconds. In some embodiments, input 300 may fluctuate due to contact bounce. If, for example, the mechanical contacts used within electronic device 250 to detect a mechanical input (e.g., input 300) are flexible, the contacts may bounce against each other due to the momentum generated by the initiation of input 300 (e.g., the mechanical act of depressing input mechanism 220 may cause the flexible contacts to repeatedly come into contact with each other and separate from each other). As a result, input 300 may oscillate over time interval was the contacts come into contact and are separated until the bouncing motion ceases and input 300 stabilizes. Electronic device 250 may wait any suitable amount of time (e.g., time interval t1), to “debounce” input 300, or allow the contact bounce within input 300 to be mitigated, before confirming input 300. The wait time may permit electronic device 250 to avoid detecting the contact bounce during interval w and to avoid incorrectly confirming input 300 and immediately detecting a second input.

Electronic device 250 may confirm input 300 using any suitable method. Electronic device 250 may detect input 300 at or shortly after time t0 using any suitable technique. For example, electronic device 250 may detect input 300 by detecting leading edge 310. As another example, electronic device 250 may detect trailing edge 320. In some embodiments (not shown), electronic device 250 may detect input 300 by detecting a transition between logic levels of input 300 (e.g., a transition from a logic low level to a logic high level). After the passage of any suitable time interval, such as interval t1, electronic device 250 may detect input 300 again. Interval t1 may include any suitable length of time, such as twenty to fifty milliseconds. If the value of input 300 detected at or shortly after time t0 matches the value of input 300 detected near the end of interval t1, electronic device 250 may confirm input 300. Electronic device 250 may detect input 300 and compare the detected values using any suitable approach. For example, control circuitry 110 may be operative to operate one or more firmware processes for receiving input 300 from electronic device 250, detecting input 300 any suitable number of times within any suitable timeframe, storing the detected values, comparing the stored values, and determining whether the stored values match.

While a detected input is in the process of being confirmed by an electronic device, the electronic device may simultaneously initiate the set up of any suitable number of predicted actions to perform. For example, electronic device 250 may detect input 300 at or shortly after time to by detecting leading edge 310, trailing edge 320, or any other suitable portion of input 300. Once electronic device 250 has initially detected input 300, control circuitry 110 may initiate any suitable number of operations during interval t1 to identify and set up at least one action that control circuitry 110 predicts may be performed once input 300 is confirmed. In some embodiments, initiating a set up of an action may include any step required to reach the goal of performing the action. In some embodiments, initiating a set up of an action may include all of the steps required to perform an action, short of performing the action itself.

In some embodiments, for example, a user may depress input mechanism 220 to select Shuffle Songs option 275 from display screen 200. Electronic device 250 may detect the user's input and may wait any suitable amount of time (e.g., interval t1) before confirming the user's input. While electronic device 250 is waiting to confirm the selection of Shuffle Songs option 275, control circuitry 110 may simultaneously set up during interval t1 any suitable number of possible actions that control circuitry 110 predicts may result from the detected input. For example, control circuitry 110 may set up an action during interval t1 to shuffle or reorganize the playback of the music media stored within electronic device 250. Alternatively, control circuitry 110 may set up an action during interval t1 to present a user with a subsequent display screen (not shown) to choose among menu options related to shuffling music media stored within electronic device 250.

Alternatively, control circuitry 110 may set up an action during interval t1 to present a user with a subsequent display screen (not shown) to confirm the desire to shuffle the music media in response to selecting Shuffle Songs option 275. Control circuitry 110 may set up a single action in response to detecting an input, or control circuitry 110 may set up all of the actions described above or any other suitable number of actions in response to detecting an input.

In some embodiments (not shown), electronic device 250 may include a single I/O interface 115 (e.g., a touch screen) that may receive an input through a touch of a display screen and that may also provide a visual output via that same display screen. If a user provides an input by touching the display screen, electronic device 250 may detect the input and may wait any suitable amount of time (e.g., interval t1) to confirm the input, just as electronic device 250 may wait during interval t1 to confirm an input from input mechanism 220. While electronic device 250 waits to confirm the user's input, control circuitry 110 may set up simultaneously any suitable number of actions that control circuitry 110 predicts may be performed in response to the user's input.

Because a touch screen may present a graphical interface for accepting an input, there may be uncertainty as to the actual spatial position of the user's input. Therefore, control circuitry 110 may set up any suitable number of actions that control circuitry 110 predicts could be performed in response to an input detected within a given radius, or area, of the user's actual input. For example, I/O interface 115 may present any suitable number of menu options to a user (not shown). The user may select one menu option so as to be taken to a subsequent menu. In addition to setting up an action that would display the subsequent menu requested by the user, control circuitry 110 may set up any suitable number of additional menus that could be displayed subsequent to the selection of other menu options within a given radius of the menu option actually selected by the user. Once the user's selection is confirmed, the correct subsequent menu may be displayed to the user on I/O interface 115 or the action associated with the selected option may be performed.

In some embodiments, control circuitry 110 may set up any suitable number of actions that control circuitry 110 predicts could be performed in response to an input within a similar context to the user's actual input. For example, a user may select Video option 235 from display screen 200 to view different video items stored within or capable of being streamed to electronic device 250. Control circuitry 110 may set up an action for a subsequent display screen that may be displayed when Video option 235 is selected (not shown), and instead or in addition may set up actions that may be selected in the context of the user's actual selection from display screen 200. For example, control circuitry 110 may set up actions for the user to view subsequent menus that could appear if a user selected Music option 225, Photos option 245, or Extras option 255.

Control circuitry 110 may simultaneously set up one or more actions using any suitable method. For example, to set up an action involving the playback of a music media file, control circuitry 110 may access a mass storage or an audio media file system, open a media file, read the media file, parse the media file, and perform any other suitable processing (e.g., read a header associated with the music media file, decode the media file including, for example, decoding a file with a .mp3 extension, and/or mix the media file into a data or audio stream to be sent to an output buffer). The step or steps included in setting up an action may depend on what action or actions may be predicted by control circuitry 110 to be performed in response to a detected input. In some embodiments, the step or steps included in setting up an action may be completed during interval t1 and, in some embodiments, one or more steps may be completed after interval t1. Thus, the set up of the predicted action may be completed prior to, concurrently with, or following the confirmation of the input.

Once an input has been confirmed by an electronic device, the action that may correspond to the confirmed input may be performed substantially immediately following the confirmation. For example, if a user selects Shuffle Songs option 275 on display screen 200 using input mechanism 220, electronic device 250 may detect the user's selection and may confirm the input. Simultaneously during the confirmation process, control circuitry 110 may set up any suitable number of possible actions that control circuitry 110 predicts may be performed in response to the user's input. For example, control circuitry 110 may set up an action to shuffle all of the music media files stored in electronic device 250.

After the user's selection of Shuffle Songs option 275 has been confirmed, electronic device 250 may substantially immediately perform the action corresponding to the confirmed input (e.g., an amplifier within playback circuitry 108 may drive a pair of headphones coupled to electronic device 250 so that a user of electronic device 250 may hear the shuffled music playing through the headphones). For example, performing the action (e.g., driving the headphones with an amplifier so that the user may hear the playback of the media file) may take on the order of 22 microseconds after the input is confirmed, because the set up process may have already decoded the media file with a codec into an output buffer for transmission to the amplifier.

In some embodiments, the process to set up an action may have been completed during interval t1, or concurrently with the end of interval t1, so that the action may be performed substantially immediately following the confirmation of an input. In such embodiments, the amount of time needed to perform the action in response to the input may be reduced by an amount of time needed to set up the action since the set up may be completed before the input may be confirmed. In some embodiments, the set up of the action may exceed the duration of interval t1, in which case the action may be substantially immediately performed following completion of the set up. In such embodiments, an action may be performed without waiting for an input to be confirmed and then subsequently waiting for the action to be set up only after the input has been confirmed. In particular, the amount of time needed to perform the action in response to the input may be reduced by an amount of time equivalent to the time used to confirm the input (e.g., interval t1) because the set up of the action may be initiated and in some cases completed, during the wait time.

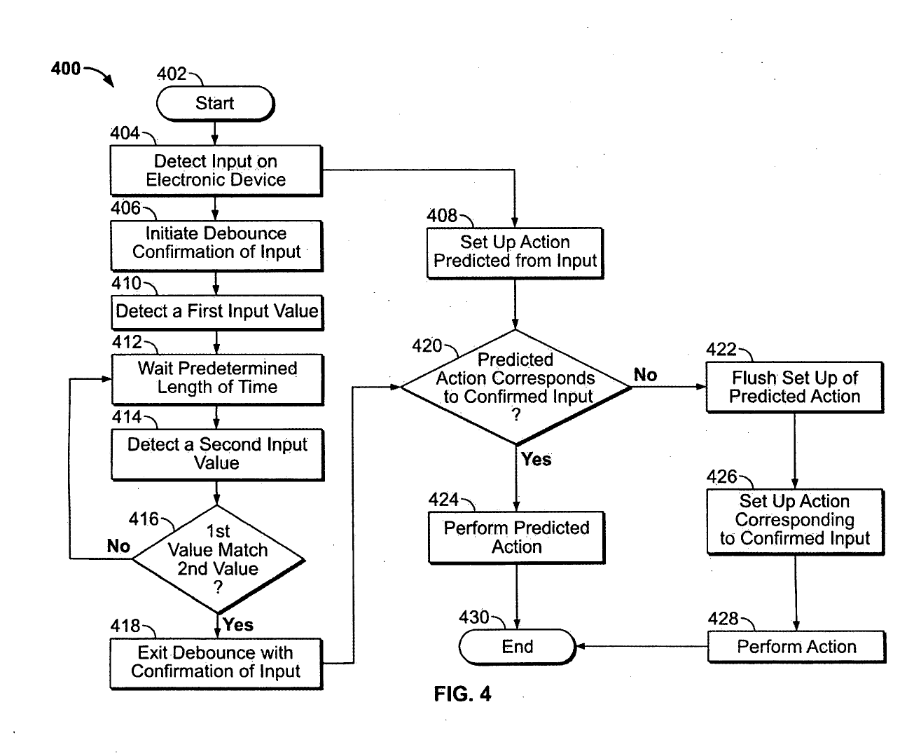

FIG. 4 is a flowchart of an illustrative process for setting up an action while an input is being confirmed in accordance with some embodiments of the invention. Process 400 may begin at step 402. At step 404, an input may be detected by an electronic device. For example, a user may depress input mechanism 220 on electronic device 250 at time t0. At step 406, the electronic device may initiate a process to confirm the input.

To confirm the input, process 400 may advance to step 410, where the electronic device may detect a first input value. For example, electronic device 250 may detect input 300 at or near time t0, including, for example, at leading edge 310, trailing edge 320, at a transition in the logic level, or any other suitable portion of input 300. Process 400 may advance to step 412, where the electronic device may wait any suitable predetermined length of time before detecting the input again. For example, electronic device 250 may wait for a predetermined interval t1 (e.g., twenty to fifty milliseconds) before detecting input 300 again. Electronic device 250 may wait during interval t1 before detecting input 300 again to allow the contact bounce that may exist in input 300 to be mitigated, or to allow input 300 to debounce, before confirming input 300. At step 414, the electronic device may detect a second input value (e.g., electronic device 250 may detect input 300 at or near the end of interval t1). Process 400 may advance to step 416, where the electronic device may determine whether the first input value obtained at step 410 matches the second input value obtained at step 414. If the values do not match, process 400 returns to step 412 and the electronic device may wait again for a predetermined length of time before detecting an input value. This repeat detection may be necessary if the electronic device is attempting to detect the input at step 414 while the input is still bouncing or chattering from contact bounce.

If, at step 416, the input values match, process 400 may advance to step 418, where the debounce confirmation process may end and the input may be confirmed. For example, electronic device 250 may detect input 300 soon after time t0 and at the end of interval t1 and if the detected values match, electronic device 250 may indicate that input 300 has been confirmed.

While process 400 is confirming the input in steps 406 through 418, process 400 may move to step 408 and simultaneously set up at least one action that the electronic device predicts may be performed in response to the detected input. The electronic device may predict which action or actions to set up using any suitable approach (e.g., a contextual or spatial approach). The electronic device may set up the action in any suitable manner, which may depend on what action or actions the electronic device predicts may be performed in response to the input. For example, control circuitry 110 (FIG. 1) may access a storage system within electronic device 250, open a file system, open a file, read the file, parse the file, and perform any other suitable processing. In some embodiments, any suitable number of additional actions may be set up at step 408. Step 408 may be completed prior to, concurrently with, or following the completion of step 418.

Process 400 may then advance to step 420, where the electronic device may determine whether the action predicted in step 408 corresponds with the input confirmed in step 418. For example, control circuitry 110 may determine whether the action set up at step 408 is intended to be performed by electronic device 250 in response to confirming input 300 at step 418. If the predicted action does not correspond to the confirmed input, process 400 may advance to step 422, where the set up of the predicted action may be flushed, or erased, by the electronic device.

In some embodiments (not shown), control circuitry 110 may perform the determination at step 420 prior to completing step 408. For example, if the set up of the predicted action is time consuming, the input may be confirmed at step 418 and control circuitry 110 may determine whether the predicted action corresponds to the confirmed input at step 420 before the set up of the predicted action is completed at step 408. In such a case, if the predicted action does not correspond to the confirmed input at step 420, process 400 may advance to step 422 and the partially completed set up from step 408 may be flushed. In some embodiments, the determination at step 420 may be performed by determining whether the confirmed input at step 418 matches the detected input from step 404.

In some embodiments, the electronic device may set up more than one predicted action at step 408 in response to detecting the input at step 404. If a predicted set up is flushed at step 422, process 400 may return to step 420 (not shown) to determine whether another predicted action set up at step 408 may correspond to the confirmed input. Process 400 may repeat this cycle between steps 420 and 422 until all of the predicted actions set up at step 408 have been flushed and process 400 advances to step 426 or until process 400 advances to step 424.

If the set up of the predicted action has been flushed at step 422 and no other predicted action set ups from step 408 correspond to the confirmed input at step 420, then process 400 may advance to step 426. At step 426, the electronic device may set up an action that corresponds to the confirmed input. At step 428, the action may be performed and process 400 may advance to step 430 and end.

If the predicted action set up at step 408 corresponds to the confirmed input at step 420, process 400 may advance to step 424, where the predicted action may be performed by the electronic device. For example, if input 300 includes a request to play a media file and control circuitry 110 sets up an action to play the media file once input 300 is confirmed, the media file may be played back by electronic device 250 substantially immediately after input 300 is confirmed at the end of interval t1. Process 400 may advance to step 430 and end.

In some embodiments, the electronic device may detect a first input, and may perform an action predicted to correspond to the detected input before the input may be stabilized (e.g., before input 300 has been debounced). The electronic device then may allow any suitable amount of time to elapse between performing the first action and detecting a second input. The elapsed time may allow the electronic device to ensure that the first input has been fully debounced before allowing another input to trigger the confirmation, set up, and performing of a second action. This process may ensure that any single input may not be erroneously interpreted as two separate events without having to introduce any additional latency period to permit the first input to stabilize.

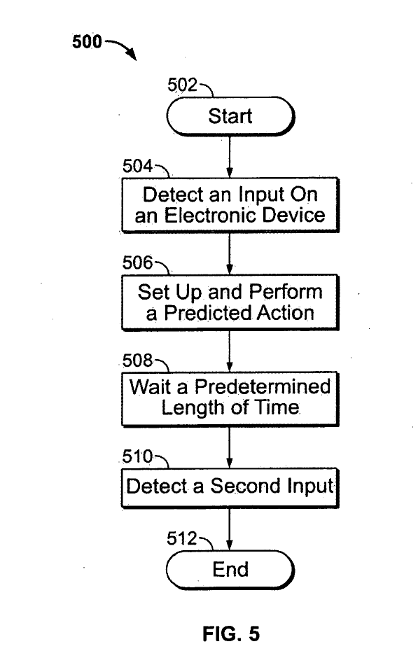

FIG. 5 is a flowchart of an illustrative process for detecting a first input and a second input in accordance with some embodiments of the invention. Process 500 may begin at step 502. At step 504, a first input may be detected by an electronic device. For example, a user may depress input mechanism 220 on electronic device 250 at time t0. At step 506, the electronic device may set up an action predicted to be performed in response to the detected input and may perform the predicted action. The predicted action may be performed at step 506 before the first input may have stabilized (e.g., the predicted action may be performed during interval w).

Process 500 may advance to step 508, and the electronic device may allow any suitable predetermined length of time (e.g., interval t1) to elapse between detecting the input at step 504 and allowing a second input to be detected. While the electronic device is waiting at step 508, the first input detected at step 504 may stabilize (e.g., input 300 may no longer be oscillating, or input 300 may have been debounced). After the predetermined length of time has elapsed, the electronic device may allow a second input to be detected. Integrating wait time into process 500 may ensure that the first input may not be incorrectly detected as two separate inputs without requiring an additional latency period to elapse for allowing the input to stabilize beyond interval t1.

Once the wait time of step 508 has lapsed, process 500 may advance to step 512, where a second input may be detected using any suitable approach, such as the approach used to detect the first input. In some embodiments, the second input may be confirmed and a second action may be predicted and performed as described with respect to an input in steps 406 through 430 of FIG. 4. In some embodiments, process 500 may return to steps 506 and 508 (not shown) to set up at least one action predicted to be performed in response to detecting the second input and to perform the predicted action. Process 500 may then advance to step 512 and end.

While there have been described apparatus and methods for setting up an action on an electronic device before an input is confirmed, it is to be understood that many changes may be made therein without departing from the spirit and scope of the invention. It will also be understood that various directional and orientational terms such as “up” and “down,” “left” and “right,” “top” and “bottom,” “side” and “edge” and “corner,” “height” and “width” and “depth,” “horizontal” and “vertical,” and the like are used herein only for convenience, and that no fixed or absolute directional or orientational limitations are intended by the use of these words. For example, the positioning of an output mechanism and/or an input mechanism within an electronic device may have any desired orientation. If reoriented, different directional or orientational terms may need to be used in their description, but that will not alter their fundamental nature as within the scope of the invention. Those skilled in the art will appreciate that the invention can be practiced by other than the described embodiments, which are presented for purposes of illustration rather than of limitation, and the invention is limited only by the claims which follow.

What is claimed is:

1. An electronic device for initiating a set up of an action, the electronic device comprising:
an input mechanism operative to receive an input; and
control circuitry, wherein the control circuitry is operative to:
detect the input;
predict at least one action to perform in response to the detected input;
set up the at least one action;
confirm the input; and
perform the at least one action in response to the confirmed input.

2. The electronic device of claim 1, wherein the control circuitry is further operative to perform the at least one action as soon as the set up of the at least one action is completed.

3. The electronic device of claim 1, wherein the control circuitry is further operative to:
detect the input a first time to obtain a first input value;
wait a predetermined length of time;
detect the input a second time to obtain a second input value; and
compare the first input value to the second input value.

4. The electronic device of claim 3, wherein the control circuitry is further operative to:
determine that the first input value matches the second input value; and
confirm the input in response to the determination.

5. The electronic device of claim 1, wherein the control circuitry is further operative to:
determine that the detected input corresponds to the confirmed input; and
perform the at least one action in response to the determination.

6. The electronic device of claim 1, wherein the control circuitry is further operative to:
determine that the detected input does not correspond to the confirmed input;
flush the set up of the at least one action;
set up at least one other action corresponding to the confirmed input; and
perform the at least one other action.

7. The electronic device of claim 1, wherein the set up of the at least one action is completed before the input is confirmed.

8. The electronic device of claim 1, wherein the set up of the at least one action is completed concurrently with the input being confirmed.

9. The electronic device of claim 1, wherein the set up of the at least one action is completed after the input is confirmed.

10. The electronic device of claim 1, wherein the input mechanism comprises at least one of an electronic device pad, a touch screen, a button, a mouse, a joystick, a track ball, a keypad, a dial, a switch, an actuator, a scroll wheel, and a click wheel.

11. The electronic device of claim 1, wherein the input comprises at least one of a voice instruction, a data instruction, a manual instruction, an instruction from a program installed in the electronic device, and an instruction based upon a sensed condition.

12. The electronic device of claim 1, wherein the at least one action is related to the play back of a media file.

13. A method for initiating a set up of an action on an electronic device, the method comprising:
detecting an input;
confirming the input;
initiating the set up of at least one action in response to detecting the input and before the input is confirmed; and
performing the at least one action.

14. The method of claim 13, wherein the performing the at least one action comprises performing the at least one action as soon as the set up of the at least one action is completed.

15. The method of claim 13, wherein the confirming the input comprises:
detecting the input a first time to obtain a first input value;
waiting a predetermined length of time;
detecting the input a second time to obtain a second input value; and
comparing the first input value to the second input value.

16. The method of claim 15, wherein the confirming the input further comprises:
determining that the first input value matches the second input value; and
confirming the input in response to the determining.

17. The method of claim 13, wherein the performing the at least one action comprises:
determining that the at least one action corresponds to the confirmed input; and
performing the at least one action in response to the determining.

18. The method of claim 13, wherein the performing the at least one action comprises:
determining that the detected input corresponds to the confirmed input; and
performing the at least one action in response to the determining.

19. The method of claim 13, wherein the performing the at least one action comprises:
determining that the at least one action does not correspond to the confirmed input;
flushing the set up of the at least one action;
setting up at least one other action corresponding to the confirmed input; and
performing the at least one other action.

20. The method of claim 13, further comprising completing the set up of the at least one action occurs before the confirming the input.

21. The method of claim 13, further comprising completing the set up of the at least one action concurrently with the confirming the input.

22. The method of claim 13, further comprising completing the set up of the at least one action after the confirming the input.

23. The method of claim 13, wherein the input comprises at least one of a voice instruction, a data instruction, a manual instruction, an instruction from a program installed in the electronic device, and an instruction based upon a sensed condition.

24. The method of claim 13, wherein the performing the at least one action comprises playing back a media file.

25. A computer-readable media encoded with machine readable instructions for initiating an action on an electronic device, the computer-readable media comprising the instructions for:
detecting an input;
predicting at least one action to perform in response to detecting the input;
confirming the input;
initiating the set up of the at least one action in response to predicting the at least one action and before the input is confirmed; and
performing the at least one action in response to confirming the input.

26. The computer-readable media of claim 25, wherein the performing the at least one action comprises performing the at least one action as soon as the set up of the at least one action is completed.

27. The computer-readable media of claim 25, further comprising the instructions for completing the set up of the at least one action before the input is confirmed.

28. The computer-readable media of claim 25, further comprising the instructions for completing the set up of the at least one action concurrently with the input being confirmed.

29. The computer-readable media of claim 25, wherein the performing the at least one action comprises performing the at least one action as soon as the input is confirmed.

30. The computer-readable media of claim 25, wherein the performing the at least one action comprises playing back a media file.
